(19) United States
(12) Patent Application Publication
(10) Pub. No.: US 2021/0003335 A1
(43) Pub. Date: Jan. 7, 2021

(54) Moisture-Based Means for Regulating Snow Production

(71) Applicants: Lincoln James Crockett, Belmont, MA (US); Giulio Valfre-Zaydenman, Belmont, MA (US); Christopher Jorgenson, Belmont, MA (US); Tony Zhao, Belmont, MA (US); Alexander Wong, Belmont, MA (US); Michael Xing, Belmont, MA (US)

(72) Inventors: Lincoln James Crockett, Belmont, MA (US); Giulio Valfre-Zaydenman, Belmont, MA (US); Christopher Jorgenson, Belmont, MA (US); Tony Zhao, Belmont, MA (US); Alexander Wong, Belmont, MA (US); Michael Xing, Belmont, MA (US)

(21) Appl. No.: 16/460,924

(22) Filed: Jul. 2, 2019

(51) Int. Cl. F25C 3/04; G01W 1/02

(52) U.S. Cl. CPC F25C 3/04; F25C 2303/048; F25C 2700/00; G01W 1/02

(57) ABSTRACT

The invention is a means of regulating how much snow is produced by a snowmaking machine based on the moisture in the environment. It utilizes a moisture sensor (such as a soil sensor), and a processor measures the resistance to determine how much snow should be made. The snow maker then receives this information and adjusts the quantity of snow that it produces. By using this invention, the value of water will be maximized and the snow will be made with the greatest efficiency.

A frequent problem among modern snow making technology surrounds the efficiency of water usage. While snow makers are designed to produce snow in ideal conditions, they fail in effective use of resources as a result of the variable weather. A common problem is the moisture level. Too much moisture in the snow would make it almost liquid, thus making it highly inefficient and a huge waste of water. This water is squished out of the snow when skis run over it, making the skiing conditions horrendous for guests as well. Our invention is a means of regulating how much snow is produced by a snowmaking machine based on the moisture in the environment. To begin with, a sensor (such as a soil sensor) detects water and moisture levels in snow. This utilizes a probe, which incorporates an analog to digital converter as well as resistors for receiving the moisture signal from the detector. The moisture level is determined by sending an electrical current between the two prongs of the probe. After the resistance between the two prongs is measured, it is sent to the analog to digital converter. It is then converted into an integer. This number is dependent on the amount of electricity that is passing between the two prongs. The lower the number is, the less electricity that is passing between the electrodes and therefore the lower the moisture in the environment, and the more optimal conditions are for snowmaking. The efficiency of the snowmaking is determined by calculating how much of the water will actually be turned into snow based on the existing snow. The computer analyzes the value of the moisture and outputs the expected efficiency. This can be done in several ways, including but not limited to: a) A display on the device. b) Different lights lighting up according to the configured thresholds. c) The moisture sensing device can be directly integrated into a snowmaking device, and change certain settings on said snowmaking device or control the amount of water flow to the snow making machine based on configured thresholds and in accordance to changing environmental conditions, with no need for human intervention.

### BRIEF DESCRIPTION OF THE DRAWINGS

FIG. 1 illustrates a circuit used to measure the voltage drop over an unknown resistor;

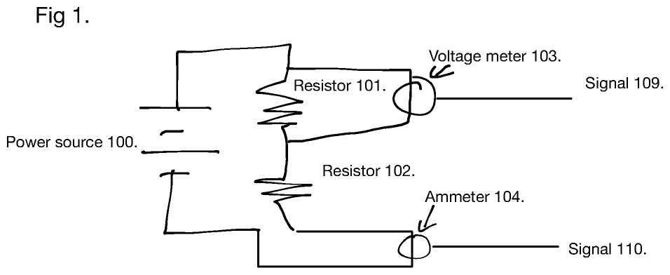

FIG. 2 is a resistor used to measure moisture in snow;

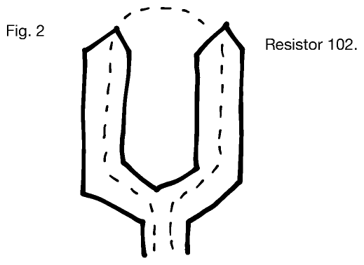

FIG. 3 is a computer that takes in 2 signals and outputs a digitized signal; and

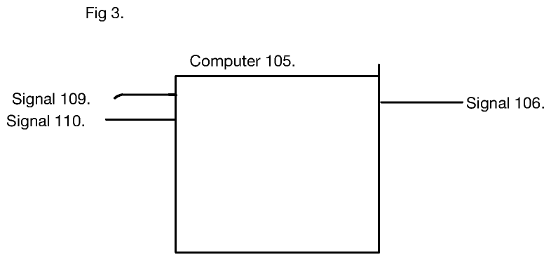

FIG. 4 shows a computer that takes the digitized signal and outputs a snowmaking recommendation signal.

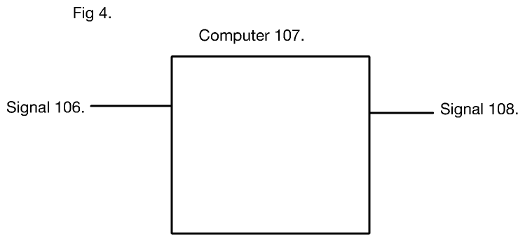

1. An electronic system, comprising: a measurement module which detects moisture levels in the environment; a configuration module which maps environmental moisture levels to desired snow production levels; and an output module which gives the ideal snow production level based on the measured moisture level.

2. The system of claim 1, further comprising the display of the gathered information on a device, or different lights lighting up according to configured thresholds.

3. The system of claim 1, further comprising the ability to alter the quantity of snow produced based on the moisture level detected.
